(19) United States
(12) Patent Application Publication
(10) Pub. No.: US 2018/0232463 A1
(43) Pub. Date: Aug. 16, 2018

(54) DYNAMIC APPLICATION LANDSCAPE PROCESSING SYSTEM

(71) Applicant: International Business Machines Corporation, Armonk, NY (US)

(72) Inventors: Amitava Chakraborty, Kolkata (IN); Diptiman Dasgupta, Kolkata (IN); Sarbajit K. Rakshit, Kolkata (IN); Sandipan Sengupta, Kolkata (IN); Shantanu Sinha, Kolkata (IN)

(21) Appl. No.: 15/434,555

(22) Filed: Feb. 16, 2017

(51) Int. Cl. G06F 17/30; G06N 99/00; G06F 17/18

(52) U.S. Cl. CPC G06F 17/30991; G06F 17/30997; G06T 11/206; G06F 17/18; G06N 99/005

(57) ABSTRACT

A system, method and program product for application landscape processing. A system is disclosed that includes: a contextual analysis engine that analyzes structured and unstructured data from external source information, internal source information, and application usage patterns to identify performance indicators; a system for storing metadata for each application in an application landscape, wherein metadata for each application specifies a set of application parameters and associated values; and a priority calculator that calculates a priority score for applications in the application landscape, wherein the priority score for a selected application is determined by evaluating performance indicators that correlate to metadata of the selected application.

### TECHNICAL FIELD

The subject matter of this invention relates to a system for processing and visualizing application landscapes, and more particularly to a system and method of dynamically analyzing and displaying applications within an application landscape for prioritization and scalability.

### BACKGROUND

Computing infrastructures such as large scale enterprises, cloud computing, and service oriented architectures have resulted in the design and implementation of large scale “application landscapes.” Illustrative application landscapes may for example include large heterogeneous information systems, complex networked application platforms, etc. Over time, application landscapes are becoming increasingly complex, and may for example include hundreds or thousands of software programs, enterprise resource planning systems, legacy systems, data warehouses, middleware, etc.

Various attempts have been made to provide tools for visualizing application landscapes to help administrators better understand and organize their behavior. For example, understanding which applications are more critical that others under different scenarios can ensure that resources are strategically implemented to ensure effective operations.

### SUMMARY

Aspects of the disclosure provide a system and method of dynamically analyzing and visualizing applications in an application landscape for prioritization and scalability.

A first aspect discloses an application landscape processing system, including: a contextual analysis engine that analyzes structured and unstructured data from external source information, internal source information, and application usage patterns to identify performance indicators; a system for storing metadata for each application in an application landscape, wherein metadata for each application specifies a set of application parameters and associated values; and a priority calculator that calculates a priority score for applications in the application landscape, wherein the priority score for a selected application is determined by evaluating performance indicators that correlate to the metadata of the selected application.

A second aspect discloses a computer program product stored on a computer readable storage medium, which when executed by a computing system, processes an application landscape, the program product including: program code that contextually analyzes structured and unstructured data from external source information, internal source information, and application usage patterns to identify performance indicators; program code for storing metadata for each application in the application landscape, wherein metadata for each application specifies a set of application parameters and assigned values; and program code that calculates a priority score for applications in the application landscape, wherein the priority score for a selected application is determined by evaluating performance indicators that correlate to the metadata of the selected application.

A third aspect discloses a computerized method for processing an application landscape, including: contextually analyzing structured and unstructured data from external source information, internal source information, and application usage patterns to identify performance indicators; storing metadata for each application in the application landscape, wherein metadata for each application specifies a set of application parameters and assigned values; and calculating a priority score for applications in the application landscape, wherein the priority score for a selected application is determined by evaluating performance indicators that correlate to the metadata of the selected application.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having an application landscape system according to embodiments.

FIG. 2 shows a visualization interface according to embodiments.

FIG. 3 depicts a table showing a prioritization scoring scheme according to embodiments.

FIG. 4 depicts a table showing a scalability scoring scheme according to embodiments.

FIG. 5 shows a flow diagram according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

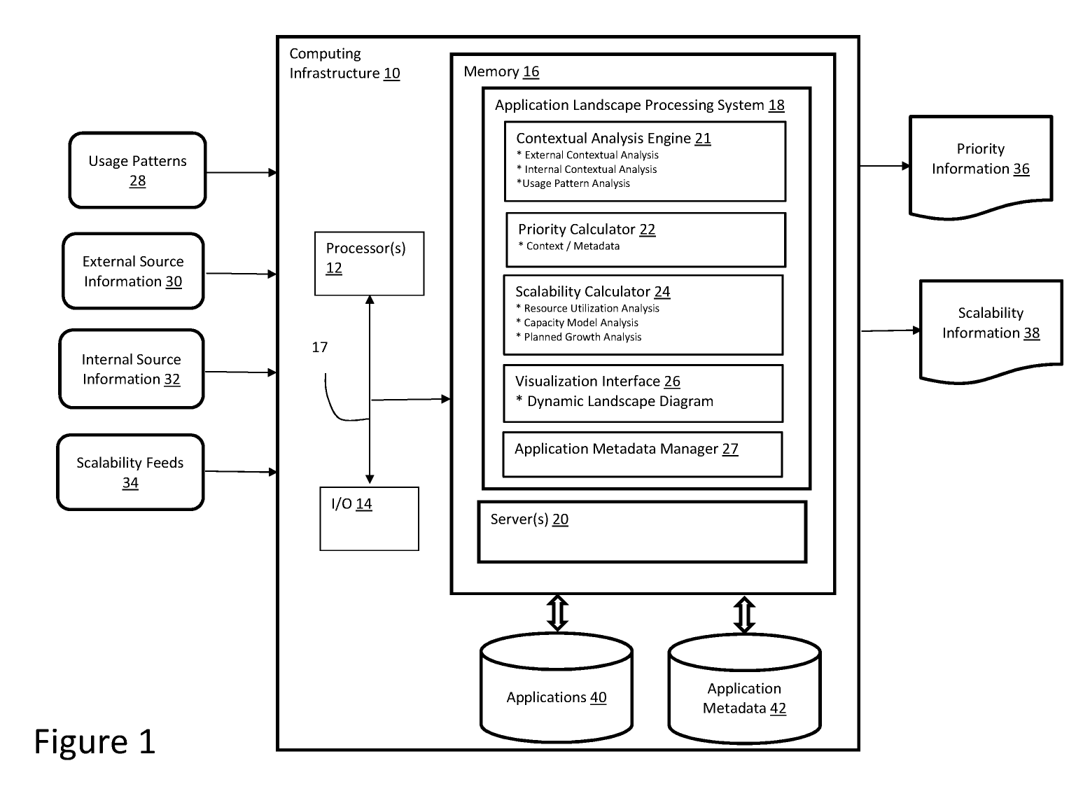

Referring now to the drawings, FIG. 1 depicts a computing infrastructure 10 having an application landscape processing system 18 that dynamically analyzes applications 40 within the computing infrastructure 10 that make up an application landscape and displays a virtualized diagram of the application landscape. Computing infrastructure 10 may comprise any intricate computing platform, which may for example include one or more servers 20 for managing applications 40 and associated data. Applications 40 may include any software program, firmware, middleware, database, service, resource, agent, etc., that functions within the computing infrastructure 10. It is understood that computing infrastructure 10 may include numerous other features and elements, such as system software, programming interfaces, network software, hardware, etc., that are not shown or described for brevity purposes.

In one illustrative embodiment, application landscape processing system 18 includes a priority calculator 22 that dynamically calculates a priority, and a scalability calculator 24 that dynamically calculates a scalability, of each application 40. The resulting priority information 36 and scalability information 38 can be outputted and/or fed into a visualization interface 26 that provides a dynamic view of the application landscape.

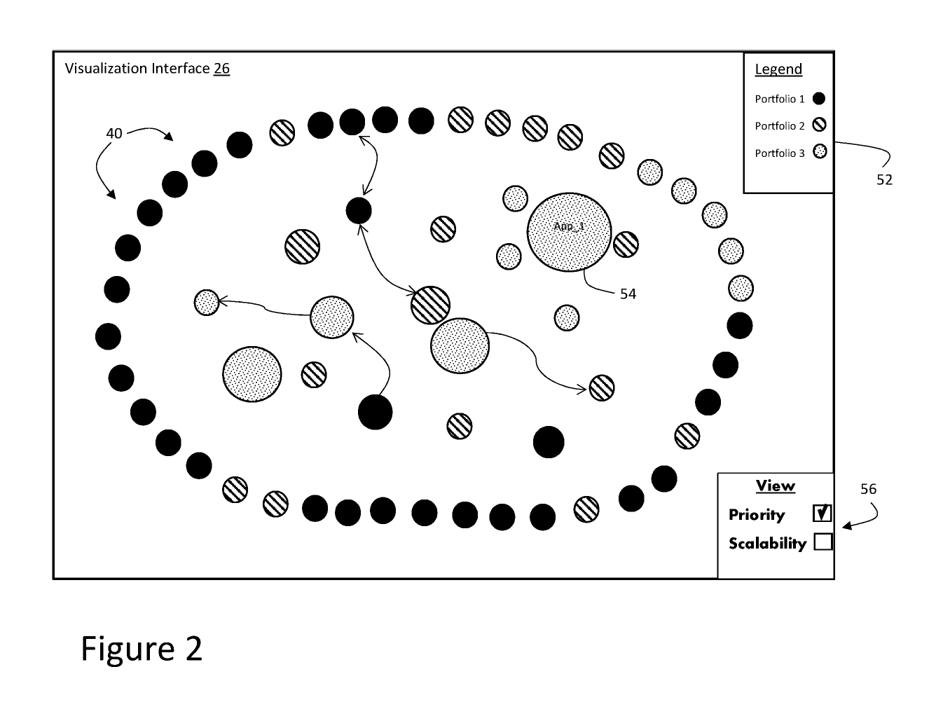

An illustrative visualization interface 26 is shown in FIG. 2, in which applications 40 are depicted as circles that are for example color coded or the like to convey information, such as belonging to a related group or family of applications 40. Flow arrows (only partially shown for brevity) describe the process flows among the applications 40. Positioning of the circles may also convey information, e.g., applications closer to the center demand the most resources. In this example, the size of each circle conveys the application's relative priority. Thus for instance, application 54 has the highest priority under the currently displayed scenario.

Different views 56 may be selected by the user including, e.g., a priority view and/or a scalability view. In the depicted example, a priority view is depicted. Although not shown, a scalability view could be selected which might for example resize the circles based on scalability. Additional interactive viewing options such as zooming in/out, rotating, clicking on circles and/or flow lines for application details, etc., would likewise be made available for the user. It is understood that the visualization interface 26 shown in FIG. 2 is for illustrative purposes only, and that any type of dynamically displayed landscape diagram could be utilized. Furthermore, it is understood that the raw data being displayed in the visualization interface 26 may be stored and managed in any manner, e.g., a table, spreadsheet, XML file, etc., that stores priority scores, scalability scores, connections, usage information, grouping information, etc.

As further detailed in FIG. 1, application landscape processing system 18 includes a contextual analysis engine 21 that analyzes structured and unstructured data from external source information 30 (i.e., information obtained from sources outside of an enterprise), internal source information 32 (i.e., information obtained from sources inside of the enterprise), and application usage patterns 28 to identify performance indicators. Performance indicators may include any value, number, grade, term, description, ranking, comparison, etc., that can be used to evaluate applications 40.

To evaluate applications 40, application landscape processing system 18 also includes an application metadata manager 27 that collects and manages metadata 42 for each application 40. Metadata 42 may for example include parameters such as domain, business area, business problem being solved, etc. Metadata 42 may be gathered in any manner, e.g., from an administrator when an application 40 is installed, from usage patterns 28, etc. In addition, although shown as being stored in a centralized location, it is understood that metadata 42 could be stored elsewhere, in a distributed manner, with the individual applications, etc.

In one aspect, metadata manager 27 provides a system for storing metadata for each application 40 in an application landscape in which metadata for each application specifies a set of application parameters and assigned values. The following is an illustrative set of metadata for an application entitled CRM.1. As shown, the metadata includes a set of parameters shown in angle brackets < > and assigned values. The number and type of parameters may differ from application to application, and the associated values describe some salient feature of the particular application.

<App_name> CRM.1
<Domain> Marketing
   <Business Area> Direct Advertising
      <Problem Solved> Scheduled email processing
<Relevant KPIs> KPI1, KPI4, KPI6

In this example, the metadata describes features of the application using parameters that include: domain, business area and problem solved. In addition, the parameters also include a set of relevant KPIs (key performance indicators) that are relevant to the application. For example, KPI1 may measure a click through rate, KPI4 may measure an opt-out rate and KPI6 may measure overall client impact.

As noted, priority calculator 22 dynamically generates a priority (e.g., a priority score) for each application 40. The priority is based on a contextual analysis of inputted usage patterns 28, external source information 30 and internal source information 32, which may include both structured and unstructured data. External source information 30 may for example include media reports, social network data, government policies and rules, and published reports. Internal source information 32 may for example include future business plans, planned mergers and acquisitions, and collected competitor information regarding future product releases, etc. Internal source information may also include email analysis, IT department plans (e.g., deployment plans, bug fixes, migration plans etc.), meeting minutes, employee feedback, etc. Usage patterns 28 may for example include application usage patterns, user group patterns, scheduled activities such, etc.

In summary, priority calculator 22 calculates a priority score for applications in the application landscape. In general, the priority score for a selected application is determined by evaluating performance indicators (generated by the contextual analysis engine 21) that correlate to metadata of a given application.

Contextual analysis engine 21 may for example use machine learning to analyze the various inputs and identify performance indicators based on some criteria, e.g., correlating to the parameters employed in the application metadata 42. For example, natural language processing may be employed to analyze media reports, social media and government data to evaluate business domains (metadata parameters) by growth potential (performance indicators). For instance, it may be determined from analyzing media reports that the automotive industry domain is slowing down while the financial services industry domain is growing. In another example, contextual analysis engine 21 may determine that a particular KPI parameter (e.g., customer satisfaction) within an organization has increased by 20% (performance indicator). In one illustrative embodiment, contextual analysis engine may use a neural network trained to identify parameters used in the application metadata 42.

Using on the contextual analysis of the structured and unstructured inputs, priority calculator 22 can then calculate priority scores for one or more applications 40 by correlating performance indicators with associated metadata. For example, applications that include the value “automotive industry” as a domain parameter value in their metadata 42 could receive a lower score relative to those applications that include “financial services” as a domain parameter value.

Furthermore, priority calculator 22 may periodically or continuously monitor and identify changes within the relevant enterprise to determine a customized set of weights for each parameter.

As noted, parameters may for example include organizational KPIs for categories such as business value, client impact, social responsibility, employee valuing, branding, etc. KPI values may be identified by the contextual analysis engine 21 and applications 40 could be evaluated for each KPI included in its associated metadata. For example, a given application may include a KPI for client impact. Based on social media analysis, it may be determined that client impact has increased under a given scenario, so the application would receive a high score for a KPI parameter involving client impact.

Thus, using the KPI example, a final priority score could be calculated as follows:

P=a·x+b·y+c·z+d·m+e·n . . . .

Where a, b, c . . . are weighting factors that sum to 1, and where x, y, z . . . are KPI parameters. For example:

x=business value in dollars

y=number of impacted customers

z=number of impacted employees

d=brand impact

e=social responsibility

. . . etc.

The weights may for example be adjusted at the enterprise level to achieve an optimized business goal for a specific period, and be set by a board of directors, automated learning system, etc.

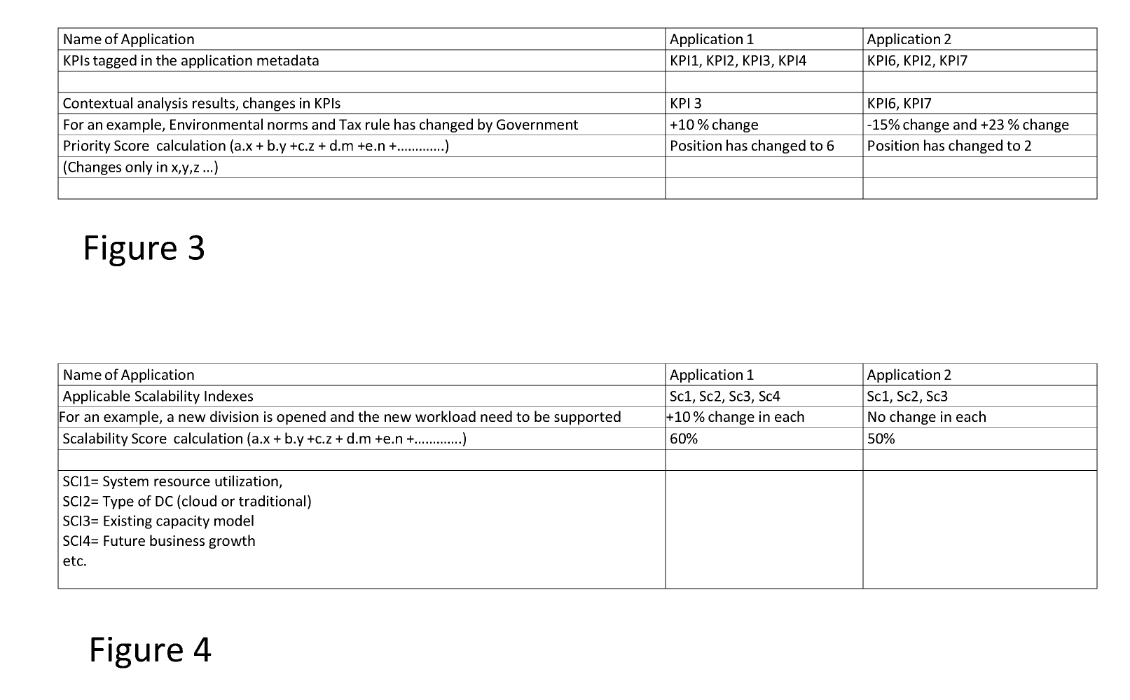

FIG. 3 depicts a table showing comparative application priority changes for two applications (Application 1 and Application 2) based on an analysis of KPI parameters. As shown, Application 1 includes four KPIs: KPI1, KPI2, KPI3 and KPI4. Application 2 includes three KPIs: KPI6, KPI2 and KPI7. Based on contextual analysis results of internal and external source information 30, 32, KPI3 which is relevant in Application 1 changed +10% and KPI6 and KPI7 changed −15% and +23% respectively. The priority score calculation results in being re-ranked with a priority of 6 and Application 2 with a priority of 2.

Referring again to FIG. 1, scalability feeds 34 are utilized by scalability calculator 24 to calculate a scalability value or score for each application and may for example include system resource utilization, existing capacity model, future business growth, whether the computing infrastructure is cloud based or a traditional data center model, etc. Once a scalability value is calculated for each application 40, the scalability value is passed to the visualization interface 26 for implementation as a user interface feature. The scalability value may for example comprise a percentage that the application 40 can be scaled/expanded based on a standard scorecard for all the applications.

The visualization interface 26 may for example display an interactive application landscape diagram that visually conveys a degree of scalability of each application based on the scalability score, wherein the degree of scalability includes visual information showing an amount each application can be enlarged or “stretched,” e.g., by depicting concentric circles including a smaller circle depicting the current application usage and a larger circle showing a maximum scalability. Alternatively, the user could select an application in the visualization interface 26 and attempt to stretch or enlarge the application (e.g., with a mouse wheel or sliding bar) to view the scaling impact, e.g., perform a “what-if” scenario.

If after stretching an application, the scalability of the application reaches 0%, the application may for example turn RED and display a message that there is zero scalability left, i.e., the application could not perform under the proposed load. In this case, if the application was implemented with a traditional data center landscape, the user might be prompted to move the application to a cloud platform for additional scalability. FIG. 4 depicts an illustrative embodiment for calculating a scalability score.

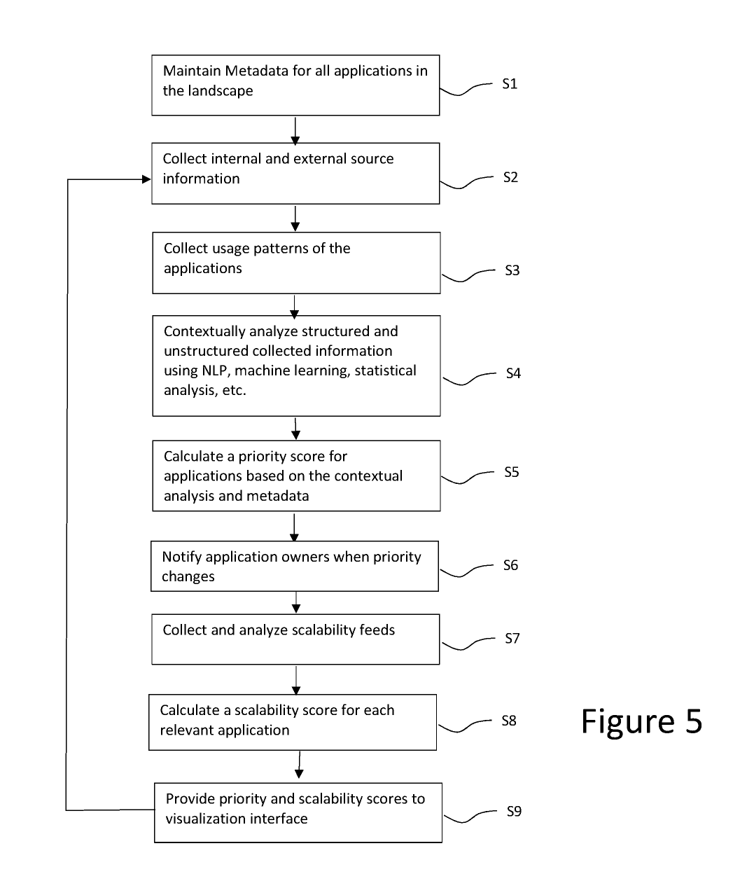

FIG. 5 depicts an illustrative flow diagram of a method of implementing an application landscape system 18. At S1, application metadata 42 is maintained for each application 40 in the landscape. At S2, external source information 30 and internal source information are collected and at S3, application usage patterns 28 are collected. At S4, structured and unstructured collected information is contextually analyzed using NLP, machine learning, statistical analysis, etc. For example, reports, social media feed, etc., are analyzed to identify and extract performance parameters relevant to the landscape. At S5, a priority score is calculate for applications 40 based on the contextual analysis and metadata 42. Depending on the situation, a priority score can be calculated for all applications 40, or for just those applications that were impacted by the contextual analysis. For example, the contextual analysis may identify performance indicators relevant to certain metadata, which is only associated with a subset of applications 40 in the landscape. In that case, only that subset of applications will have a recalculated priority score.

In another example, contextual analysis may capture updated KPI values (e.g., customer service has improved 10%, revenue in the services division is down, etc.). In this case, those applications that include such KPIs in their metadata would have their priority score recalculated based on the captured KPI values.

At S6, application owners (i.e., agents, admins, etc.) may be notified of a change in priority.

At S7, scalability feeds are collected and analyzed. The process may likewise use contextual analysis of structured and unstructured data to identify parameters that are relevant to scalability of an application. At S8, a scalability score is calculated for each application or for those applications that experienced a change. At S9, the priority and scalability scores are provided to the visualization interface system 26, which is adapted to visually convey priority and scalability information as shown in FIG. 2. The process then loops, e.g., periodically or based on a triggering event.

It is understood that application landscape processing system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing infrastructure 10 that may comprise any type of computing device and for example includes at least one processor 12, memory 16, an input/output (I/O) 14 (e.g., one or more I/O interfaces and/or devices), and a communications pathway 17. In general, processor(s) 12 execute program code which is at least partially fixed in memory 16. While executing program code, processor(s) 12 can process data, which can result in reading and/or writing transformed data from/to memory and/or I/O 14 for further processing. The pathway 17 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the application landscape analyzer 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. An application landscape processing system, comprising:
a contextual analysis engine that analyzes structured and unstructured data from external source information, internal source information, and application usage patterns to identify performance indicators;
a system for storing metadata for each application in an application landscape, wherein metadata for each application specifies a set of application parameters and associated values; and
a priority calculator that calculates a priority score for applications in the application landscape, wherein the priority score for a selected application is determined by evaluating performance indicators that correlate to the metadata of the selected application.

2. The application landscape processing system of claim 1, wherein the contextual analysis engine utilizes at least one of natural language processing and machine learning to identify performance indicators from the unstructured data.

3. The application landscape processing system of claim 2, wherein the contextual analysis engine further utilizes statistical analysis of the application usage patterns to quantify performance indicators.

4. The application landscape processing system of claim 1, wherein the application parameters are selected from at least one of: domain, business area, business problem being solved, or relevant key performance indicators.

5. The application landscape processing system of claim 1, further comprising:
a system for calculating a scalability score for each application based on inputted feeds that are selected from at least one of: system resource utilization, type of data center, an external capacity model or future business growth; and
a visualization interface that displays an interactive application landscape diagram that visually conveys a degree of scalability of each application based on the scalability score, wherein the degree of scalability includes visual information showing an amount each application can be stretched.

6. The application landscape processing system of claim 1, further comprising a visualization interface for displaying an application landscape diagram that conveys at least one of application priority and application scalability.

7. The application landscape processing system of claim 1, wherein the external source information includes content having at least one of: a media report, a social media feed, a government publication or a published report.

8. A computer program product stored on a computer readable storage medium, which when executed by a computing system, processes an application landscape, the program product comprising:
program code that contextually analyzes structured and unstructured data from external source information, internal source information, and application usage patterns to identify performance indicators;
program code for storing metadata for each application in the application landscape, wherein metadata for each application specifies a set of application parameters and assigned values; and
program code that calculates a priority score for applications in the application landscape, wherein the priority score for a selected application is determined by evaluating performance indicators that correlate to the metadata of the selected application.

9. The program product of claim 8, wherein the contextual analysis utilizes at least one of natural language processing and machine learning to identify performance indicators from the unstructured data.

10. The program product of claim 9, wherein the contextual analysis further utilizes statistical analysis of the application usage patterns to identify performance indicators.

11. The program product of claim 8, wherein the application parameters include at least one of: domain, business area, business problem being solved or relevant key performance indicators.

12. The program product of claim 8, further comprising program code for calculating a scalability score for each application based on inputted feeds that are selected from at least one of: system resource utilization, type of data center, an external capacity model, or future business growth.

13. The program product of claim 8, further comprising program code for displaying an application landscape diagram that conveys at least one of application priority and application scalability.

14. The program product of claim 8, wherein the external source information includes content having at least one of: a media report, a social media feed, a government publication or a published report.

15. A computerized method for processing an application landscape, comprising:
contextually analyzing structured and unstructured data from external source information, internal source information, and application usage patterns to identify performance indicators;
storing metadata for each application in the application landscape, wherein metadata for each application specifies a set of application parameters and assigned values; and
calculating a priority score for applications in the application landscape, wherein the priority score for a selected application is determined by evaluating performance indicators that correlate to the metadata of the selected application.

16. The computerized method of claim 15, wherein the contextual analysis utilizes at least one of natural language processing and machine learning to identify performance indicators from the unstructured data.

17. The computerized method of claim 16, wherein the contextual analysis further utilizes statistical analysis of the application usage patterns to identify performance indicators.

18. The computerized method of claim 15, wherein the application parameters are selected from at least one of: domain, business area, business problem being solved or relevant key performance indicators.

19. The computerized method of claim 15, further comprising calculating a scalability score for each application based on inputted feeds that are selected from at least one of: system resource utilization, type of data center, an external capacity model or future business growth.

20. The computerized method of claim 15, further comprising displaying an application landscape diagram that conveys at least one of application priority and application scalability.
